(19) United States
(12) Patent Application Publication
(10) Pub. No.: US 2026/0313399 A1
(43) Pub. Date: Oct. 8, 2026

(54) ENHANCED REDUNDANCY IN A NETWORK

(71) Applicants: RAKUTEN MOBILE, INC., Tokyo (JP); Rakuten Symphony, Inc., Tokyo (JP)

(72) Inventors: Vishal ARORA, Tokyo (JP); Bikas KAR, Karnataka (IN); Sudhakar PANDEY, Tokyo (JP); Abhishek SINGH, Tokyo (JP)

(73) Assignees: RAKUTEN MOBILE, INC., Tokyo (JP); Rakuten Symphony, Inc., Tokyo (JP)

(21) Appl. No.: 19/170,134

(22) Filed: Apr. 4, 2025

(51) Int. Cl. H04W 24/04

(52) U.S. Cl. CPC H04W 24/04

(57) ABSTRACT

Provided are apparatus, method, and device for automatically perform enhanced redundancy. According to example embodiments, the apparatus may be configured to: communicate with a core network via a first communication unit comprising one of a distributed communication unit and a centralized communication unit; detect a failure at the first communication unit; and switch communication to a second communication unit comprising another of the distributed communication unit and the centralized communication unit; wherein the distributed communication unit may include a radio interface unit of distributed unit (RIU-D) or a next generation distributed unit (NGDU), and wherein the centralized communication unit may include a secure telephone unit (STU).

### FIELD

The present disclosures relate to enhancement of redundancy in a telecommunications network.

### BACKGROUND

The information disclosed in this background section is only for enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

Several types of RAN architecture have been proposed in recent history, such as a Distributed RAN (DRAN) and a Centralized RAN (CRAN), where different hardware, software, and other components may be installed and implemented at a particular cell site depending on a particular RAN architecture which the cell site is implementing.

### SUMMARY

Example embodiments of the present disclosure automatically perform enhanced redundancy. As such, example embodiments of the present disclosure provide a redundancy solution that enables seamless switching between CRAN architecture solution and DRAN architecture solution in light of failures, without impact on service quality, observable changes at the end user, or impact on operator revenue.

According to example embodiments, an apparatus is provided. The apparatus may be configured to: communicate with a core network via a first communication unit comprising one of a distributed communication unit and a centralized communication unit; detect a failure at the first communication unit; and switch communication to a second communication unit comprising another of the distributed communication unit and the centralized communication unit; wherein the distributed communication unit may include a radio interface unit of distributed unit (RIU-D) or a next generation distributed unit (NGDU), and wherein the centralized communication unit may include a secure telephone unit (STU).

According to example embodiments, a method is provided. The method may include: communicating with a core network via a first communication unit comprising one of a distributed communication unit and a centralized communication unit; detecting a failure at the first communication unit; and switching communication to a second communication unit comprising another of the distributed communication unit and the centralized communication unit; wherein the distributed communication unit may include a radio interface unit of distributed unit (RIU-D) or a next generation distributed unit (NGDU), and wherein the centralized communication unit may include a secure telephone unit (STU).

According to example embodiments, a non-transitory computer-readable recording medium is provided. The non-transitory computer-readable recording medium may have recorded thereon instructions executable by an apparatus to cause the apparatus to perform a method including: communicating with a core network via a first communication unit comprising one of a distributed communication unit and a centralized communication unit; detecting a failure at the first communication unit; and switching communication to a second communication unit comprising another of the distributed communication unit and the centralized communication unit; wherein the distributed communication unit may include a radio interface unit of distributed unit (RIU-D) or a next generation distributed unit (NGDU), and wherein the centralized communication unit may include a secure telephone unit (STU).

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a block diagram of an example system configuration for performing enhanced redundancy in a network, according to one or more example embodiments;

FIG. 2 illustrates a flow diagram of an example method for performing enhanced redundancy, according to one or more example embodiments;

FIG. 3 illustrates a diagram of example components of a device for implementing one or more example embodiments; and

FIG. 4 illustrates a diagram of an example of implementation environment in which systems and/or method, described herein, may be implemented.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part). Further, the order of one or more operations may be switched, as long as these modifications may not affect the resulting scope of the present disclosure.

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B. Further still, where only one item is intended, the term “one” or similar language is used.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

The foregoing disclosure provides illustration and description but is not intended to be exhaustive or to limit the implementations to the precise form disclosed. Modifications and variations are possible in light of the above disclosure or may be acquired from practice of the implementations.

It shall be noted that, descriptions of example embodiments of the present disclosure may include terms and names defined in one or more standard organizations, such as the 3rd Generation Partnership Project (3GPP) standard organization, the European Telecommunications Standards Institute (ETSI) standard organization, the Open Radio Access Network (O-RAN) Alliance standard organization, and the like. For instance, the terms “DRAN”, “CRAN”, “STU”, “RIU-D”, “NGDU” “RRH”, “EMS”, “OSS”, and the like, as well as the associated features and operations, are to be interpreted as consistent with those specified in one or more technical specifications, unless described otherwise.

Further, although some embodiments of the present disclosure may be described herein with reference specific components of 5G system, it can be understood that the scope of the present disclosure should not be limited thereto. Specifically, example embodiments of the present disclosure may also apply to any suitable network elements in any suitable telecommunication system, such as a 4G LTE system, a 6G system, and the like, without departing from the scope of the present disclosure.

As described above, a particular cell may have installed different kinds of hardware, software, and other components depending on a particular RAN architecture which the cell site is implementing.

In the related art, a particular cell site may implement only one RAN architecture and have installed hardware, software, and other components specific to only such one RAN architecture. Such configuration lacks redundancy and poses a risk should any hardware specific to a particular RAN architecture fail, and there is no clearly defined method or configuration to provide redundancy in case of failures.

Should hardware failures occur, service interruptions and downtime may occur until the failed hardware is manually repaired and/or replaced, causing negative effects to the operations of the network as well as impacting average revenue per user (ARPU) of associated operators.

Accordingly, system, methods, devices, and the like, provided in the example embodiments of the present disclosure automatically perform enhanced redundancy.

According to example embodiments, the apparatus may first communicate with a core network. Such communication may be performed via a first communication unit which may include one of a distributed communication unit and a centralized communication unit. The apparatus may then detect a failure at the first communication unit, and subsequently switch communication to a second communication unit that may include another of the distributed communication unit and the centralized communication. In this regard, the distributed communication unit may include a radio interface unit of distributed unit (RIU-D) or a next generation distributed unit (NGDU), while the centralized communication unit may include a secure telephone unit (STU).

Ultimately, example embodiments of the present disclosure automatically perform enhanced redundancy, which provide a redundancy solution that enables seamless switching between CRAN architecture solution and DRAN architecture solution in light of failures, without impact on service quality, observable changes at the end user, or impact on operator revenue.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the system of the present disclosure, according to one or more embodiments, are provided in the following.

### Example System Architecture

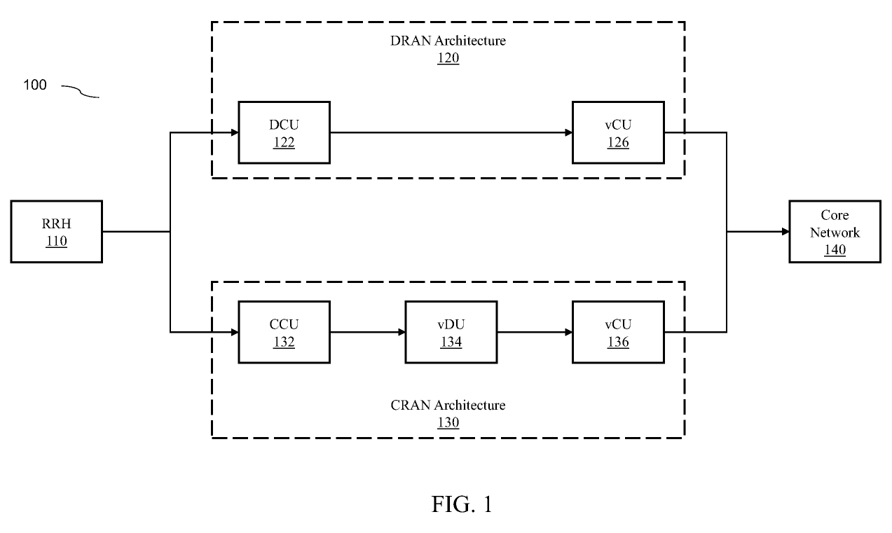

FIG. 1 illustrates a block diagram of an example system configuration 100 for performing enhanced redundancy in a network, according to one or more example embodiments. As illustrated in FIG. 1, system configuration 100 may include a remote radio head (RRH) 110, a distributed RAN (DRAN) architecture 120, a centralized RAN (CRAN) architecture 130, and a core network 140, although it is understood that the system configuration 100 may include more or fewer components than as illustrated in FIG. 1, and/or may be arranged in a manner different from as illustrated in FIG. 1, without departing from the scope of the present disclosure.

According to example embodiments, one or more components of the system configuration 100 may be implemented/installed at a cell site (hereinafter “current cell site“). For example, the RRH 110, the DCU 122, and the CCU 132 may all be implemented/installed at a cell site.

The RRH 110 may include a transceiver configured to receive communications from wireless devices, such as user equipment (UEs), process said communications, and forward said communications to the core network 140 (i.e., via the DRAN architecture 120, CRAN architecture 130, etc.) The RRH may also perform additional operations associated with radio frequency, such as signal processing, analogue-to-digital/digital-to-analogue conversion, monitoring, and the like.

According to example embodiments, the RRH 110 may be communicatively coupled to both the DRAN architecture 120 and the CRAN architecture 130 via the DCU 122 and the CCU 132, respectively. In this regard, according to example embodiments, the RRH 110 may communicate with only one of DCU 122 and CCU 132 at any particular time, in order to connect the wireless devices to the core network.

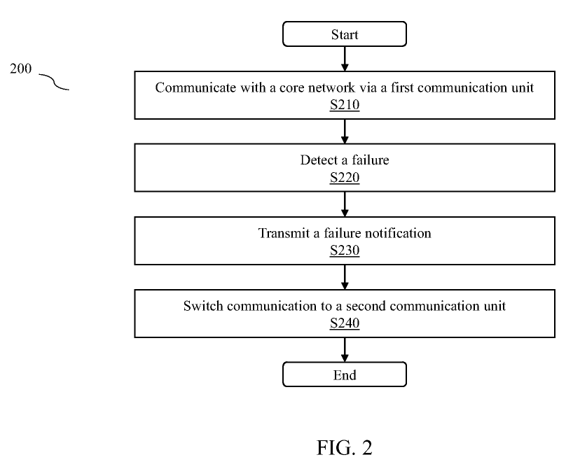

Further, the RRH 110 may be configured to perform one or more operations or actions for enhancing redundancy. Example operations performable by the RRH 110 for performing enhanced redundancy are described below with reference to FIG. 2.

The DRAN architecture 120 may refer to a radio access network (RAN) architecture where remote radio units (RRUs) (i.e., RRHs) and baseband units (BBUs) are installed at every cell sites. Here, it is understood that the functionality of a BBU may be split into a distributed unit (DU) and a centralized unit (CU).

In this regard, the DRAN architecture 120, which is being implemented at the current cell site, may include at least a distributed communication unit (DCU) 122 (i.e., communication unit for DRAN architecture), and a virtualized centralized unit (vCU) 126 which is performing the functionality of the CU. The DCU may include either a radio interface unit of distributed unit (RIU-D) or a next generation distributed unit (NGDU) which are performing the functionality of the DU.

Further, according to example embodiments, the DRAN architecture 120 may be communicatively coupled to the RRH 110 and the core network 140, such that the RRH 110 may transmit signals and communicate with the core network 140 via the DCU 122 and the vCU 126 of the DRAN architecture 120.

The CRAN architecture 130 may refer to a radio access network (RAN) architecture where remote radio units (RRUs) (i.e., RRHs) are installed at every cell sites, while baseband units (BBUs) associated with said cell sites are co-located together at a location outside of said cell sites.

In this regard, the CRAN architecture 130, which is being implemented at the current cell site, may include at least a centralized communication unit (CCU) 132 (i.e., communication unit for CRAN architecture), a virtualized distributed unit (vDU) 134 which is performing the functionality of the DU, and a virtualized centralized unit (vCU) 136 which is performing the functionality of the CU. The CCU 132 may include a secure telephone unit (STU). Further, according to example embodiments, the CRAN architecture 130 may be communicatively coupled to the RRH 110 and the core network 140, such that the RRH 110 may transmit signals and communicate with the core network 140 via the STU 132, the vDU 134, and the vCU 136 of the CRAN architecture 130.

The core network 140 may include a core or backbone of a telecommunications network, such as a 5G core, and the like.

It is understood that the DRAN architecture 120 and the CRAN architecture 130 may be communicatively coupled to the core network 140 through any appropriate network components, such as an element management system (EMS), an operation support system (OSS), data centers, and the like.

### Example Operations for Performing Enhanced Redundancy in the Present Disclosure

In the following, several example operations are performable by the apparatus of one or more example embodiments of the present disclosure are described with reference to FIG. 2.

FIG. 2 illustrates a flow diagram of an example method 200 for performing enhanced redundancy, according to one or more example embodiments. One or more operations in method 200 may be performed by the apparatus of one or more example embodiments of the present disclosure. The apparatus may be configured to perform enhanced redundancy. According to example embodiments, the apparatus may include a remote radio head (RRH).

As illustrated in FIG. 2, at operation S210, the apparatus may be configured to communicate with a core network via a first communication unit. The first communication unit may include one of a distributed communication unit and a centralized communication unit.

According to example embodiments, the distributed communication unit may include a radio interface unit of distributed unit (RIU-D) or a next generation distributed unit (NGDU). According to example embodiments, the centralized communication unit may include a secure telephone unit (STU).

The RIU-D and the NGDU may be part of a distributed radio access network (DRAN) architecture, while the STU may be part of a centralized radio access network (CRAN) architecture. In this regard, the apparatus may be communicatively coupled to both the distributed communication unit (i.e., RIU-D or NGDU) and the centralized communication unit (i.e., STU), but is only communicating with (through) one of the distributed communication and the centralized communication unit at a time (i.e., during operation S210). Further, according to example embodiments, both the distributed communication unit (i.e., RIU-D or NGDU) and the centralized communication unit (i.e., STU), as well as the apparatus (e.g., RRH) may be installed at a cell site.

The communication may include any kind of communication that is part of the functionality of an RRH to connect a device (i.e., UE) to a core network. The method then proceeds to operation S220.

At operation S220, the apparatus may be configured to detect a failure at the first communication unit.

For example, if the apparatus is communicating with the core network via the RIU-D during operation S210 (i.e., the first communication unit corresponds to the distributed communication unit which corresponds to RIU-D), the apparatus may detect a failure at the RIU-D during operation S220.

The failure may include any kind of failures associated with the first communication unit (NGDU, RIU-D, or STU). For example, according to example embodiments, the failure may include a failure associated with hardware of the RIU-D.

Further, the apparatus may detect the failure through any appropriate means. For example, the apparatus may be configured to monitor statuses, parameters, and the like of the first communication unit during the communication (i.e., during operation S210), and detect the failure by itself. In another example, the apparatus may receive a notification from a monitoring tool (software, application, modules, etc.) that is monitoring statuses, parameters, and the like of the first communication unit during the communication (i.e., during operation S210), where the notification may indicate the failure. The method then proceeds to operation S230.

At operation S230, the apparatus may be configured to transmit a failure notification.

The failure notification may include information related to the detected failure, such as the first communication unit itself (i.e., NGDU, RIU-D, or STU), the type of failure, the time of failure detection, and the like. Further, the failure notification may be transmitted to a network operator. The method then proceeds to operation S240.

At operation S240, the apparatus may be configured to switch communication to a second communication unit. The second communication unit may include another of the distributed communication unit and the centralized communication unit different from the first communication unit.

For example, if the apparatus is communicating with the core network via the RIU-D during operation S210 and detect the failure at the RIU-D during operation S220 (i.e., the first communication unit corresponds to the distributed communication unit (which corresponds to RIU-D)), the apparatus may then switch communication from RIU-D to STU during operation S230 such that the apparatus is communicating with the core network via the STU (i.e., the second communication unit corresponds to the centralized communication unit different from the first communication unit, where the centralized communication unit corresponds to the STU).

Subsequently, the apparatus may continue (resume) the communication with the core network via the second communication unit.

The apparatus may utilize any appropriate method and technique to switch communication from the first communication unit to the second communication unit, as long as the communication between the apparatus and the core network via the first communication unit is halted, and is resumed/continued via the second communication unit.

According to example embodiments, the apparatus may switch communication to the second communication unit automatically after detecting the failure during operation S220 and/or after transmitting the failure notification during operation S230.

According to example embodiments, the apparatus may switch communication to the second communication unit in response to receiving a request to switch communication unit. In particular, for example, after transmitting the failure notification to the network operator, the network operator may transmit a request to the apparatus to switch communication unit for communicating with the core network from the first communication unit to the second communication unit.

In this regard, after the communication is switched to the second communication unit, the network operator may accordingly perform root cause analysis for the failure detected at the first communication unit, as well as plan site visit to perform on-site recovery in order to address the failure and return the first communication unit back to operation. The on-site recovery may include maintenance operations, such as for example, replacement of hardware associated with the first communication unit and perform new site integration.

It is noted that, if no failure is detected during operation S220, the apparatus may continue to communicate with the core network via the first communication network.

Upon performing operation S240, the method 200 may be ended or be terminated. Alternatively, method 200 may return to operation S210, such that the at least one processor may be configured to repeatedly perform, for at least a predetermined amount of time, the communicating with the core network (at operation S210), the detecting the failure (at operation S220), the transmitting the failure notification (at operation S230), and the switching the communication (at operation S240).

For example, after switching the communication to the second communication unit and after the first communication unit has been repaired/replaced, the apparatus may communicate with the core network via the second communication unit and detect failure at the second communication unit. Accordingly, the apparatus may return to operation S210, such that the at least one processor may be configured to repeatedly perform, for at least a predetermined amount of time, the communicating with the core network (at operation S210), the detecting the failure (at operation S220), the transmitting the failure notification (at operation S230), and the switching the communication (at operation S240).

Accordingly, the above processes provide a redundancy solution that enables seamless switching between CRAN architecture solution and DRAN architecture solution in light of failures, without impact on service quality, observable changes at the end user, or impact on operator revenue. The above processes also reduce overall downtime of the network and maintain cell site availability.

### Various Aspects of Embodiments

In view of the above, example embodiments of the present disclosure provide a redundancy solution that enables seamless switching between CRAN architecture solution and DRAN architecture solution in light of failures, without impact on service quality, observable changes at the end user, or impact on operator revenue.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

One or more components of the system of the example embodiments (e.g., RRH, etc.), as well as the operations associated therewith (e.g., one or more operations in FIG. 2, etc.), may be implemented in one or more systems, devices, or hardware components, such as one or more servers, and the like. In the following, descriptions of a device in which the systems or components of the example embodiments may be implemented are provided. It is contemplated that one or more operations or methods described above with reference to FIG. 2 may be performed by the device. For instance, the one or more operations or methods may be performed by at least one processor of the device upon executing machine-readable instructions or computer-readable instructions stored in a memory or a storage component of the device.

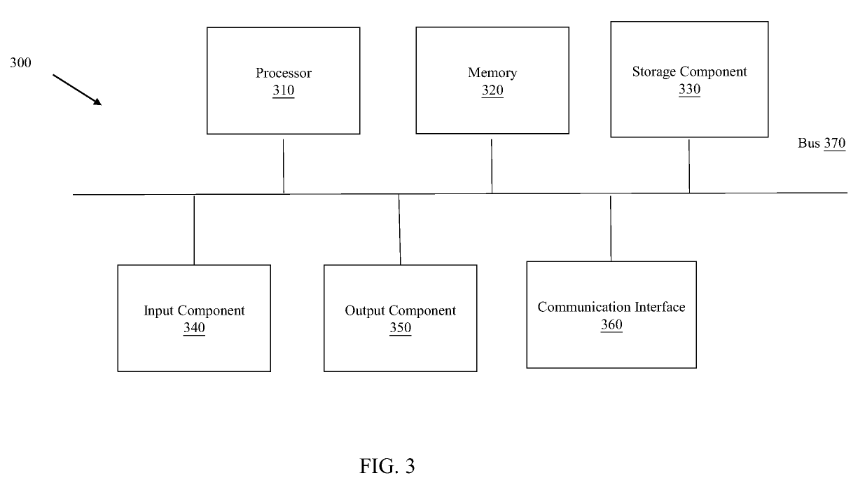

FIG. 3 illustrates an embodiment of a device 300 for implementing one or more example embodiments. As shown in FIG. 3, the device 300 includes a processor 310, a memory 320, a storage component 330, an input component 340, an output component 350, a communication interface 360, and a bus 370.

The processor 310, as used herein, means any type of computational circuit that may comprise hardware elements and software elements. The processor 310 may be embodied as a multi-core processor, a single core processor, or a combination of one or more multi-core processors and one or more single core processors, a distributed processing system, or the like. The processor 310 may be a Central Processing Unit (CPU), a graphics processing unit (GPU), an accelerated processing unit (APU), an application-specific integrated circuit (ASIC), or another type of processing component.

Memory 320 includes a non-transitory computer readable medium. Memory 320 includes a random-access memory (RAM), a read only memory (ROM), and/or another type of dynamic or static storage device (e.g., a flash memory, a magnetic memory, and/or an optical memory) that stores information and/or instructions for use by processor 310. The memory 320 comprises machine-readable instructions which are executable by the processor 310. These machine-readable instructions when executed by the processor 310 causes the processor 310 to perform one or more method steps of an embodiment described herein.

Storage component 330 stores information and/or software related to the operation and use of the device 300. For example, storage component 330 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 340 is configured to receive information, such as user input. For example, the input component 340 may include, but not be limited to, a touch screen display, a keyboard, a keypad, a mouse, a button, a switch, and/or a microphone. Additionally, or alternatively, the input component 340 may include a sensor for sensing information (e.g., a global positioning system (GPS), an accelerometer, a gyroscope, and/or an actuator).

Output component 350 is configured to provide output information from the device 300. For example, the output component 350 may be, but not limited to, a display, a speaker, an instruction device to an external device, and/or one or more light-emitting diodes (LEDs).

Communication interface 360 is an interface that provides a communication connection to other devices, such as external devices and internal devices. The connection by the communication interface 360 can be a wired connection, a wireless connection, or a combination of wired and wireless connections, and can be a direct connection or an indirect connection via a communication network that exists between the device 300 and other devices. In other words, the standard of the communication interface 360 is not limited.

The bus 370 acts as an interconnect between the processor 310, the memory 320, the storage component 330, the input component 340, the output component 350, and the communication interface 360 of the device 300. The bus 370 may include a wired interconnection or a wireless interconnection.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300. Further, one or more method steps described in any of the embodiments may be performed utilizing a plurality of device 300 in communication with one another.

Further, according to example embodiments, the device 300 may include one or more elements from the system architecture described above in relation to FIG. 1. For example, the system 300 may include the RRH.

In the present disclosure, specific tasks may be performed using AI/ML (Artificial Intelligence/Machine Learning) models. An AI/ML model is a model generated using one or more AI technologies, one or more ML algorithm or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

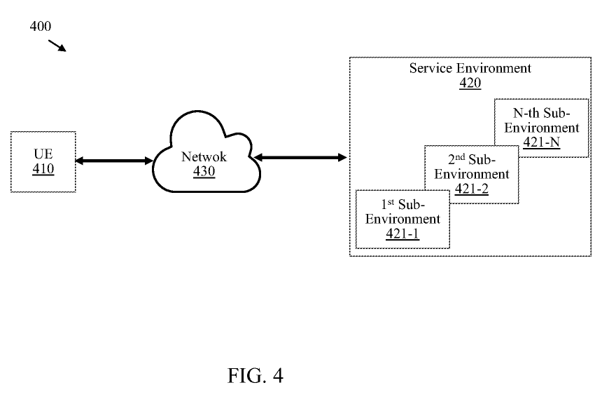

FIG. 4 is a diagram of an example of implementation environment 400 in which systems and/or method, described herein, may be implemented. The implementation environment 400 includes a UE (User equipment) 410, a service environment 420, and a network 430. The service environment 420 include one or more sub-environments 421. To illustrate this, FIG. 4 shows, for convenience, examples of a 1st sub-environment 421-1, a 2nd sub-environment 421-2, and an N-th sub-environment 421-N (where N is any natural number).

The UE 410 is connected to the network 430, and the network 430 is connected to the service environment 420. The connections may be wired, wireless, or a combination of both wired and wireless. The UE 410 and the service environment 420 are connected via the network 430.

The UE 410 is a device that communicates with the service environment 420. The UE 410 receives information from the service environment 420 and/or sends information to the service environment 420. Also, the UE 410 may generate and/or store information to be transmitted, as necessary. Also, the UE 410 may store and/or process information that is received, as necessary.

The example FIG. 4 refers to the “UE”. However, it should be understood by those skilled in the art that general terms such as “user device,” “terminal,” “terminal device,” “communication device,” and “communication terminal” can be used interchangeably with the term “UE.”

For example, the UE 410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 420 is an environment that communicates with the UE 410 to provide one or more services. The service environment 420 receives information from the UE 410 and/or sends information to the UE 410. Also, the service environment 420 may generate and/or store information to be transmitted, as necessary. Also, the service environment 420 may store and/or process information that is received, as necessary. For example, the service environment 420 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 4 refers to the “service environment”. The term "service environment" is used to refer to the broader context within which services operate. For example, cloud environments, platforms, computing systems, network systems, and cloud systems generally represent the environments in which services are conducted, and these are included within the "service environment." However, the "service environment" is not limited to these examples. Additionally, the specific types of environments within the "service environment" are not restricted. For instance, cloud environments and cloud systems can be categorized as private cloud, public cloud, hybrid cloud, or multi-cloud, all of which are included within the "service environment.”

The one or more services provided by the service environment 420 is not specifically limited and can be adjusted according to the embodiments. For example, the services may include a service that provides information to the UE 410, a service that stores information from the UE 410, or a service that performs processing based on information from the UE 410 and returns the results of the processing.

In an embodiment, the Service Environments 420 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as "Virtual" or "Virtualized" to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 420 includes one or more devices, such as servers and network devices, which provide services or perform processes. The placement of these devices within the service environment 420 can be determined as appropriate. Additionally, if the service environment 420 includes one or more sub-environments 421, the placement of devices can be determined based on predetermined policies for each sub-environment 421. For example, devices related to the first service may be placed in the 1st sub-environment 421-1, and devices related to the second service may be placed in the 2nd sub-environment 421-2. In another example, devices expected to have a higher load than a predetermined threshold may be placed in the 1st sub-environment 421-1, while devices expected to have a lower load than the predetermined threshold may be placed in the 2nd sub-environment 421-2. In this way, specific devices can be placed in specific sub-environments 421. Conversely, each sub-environment 421 can be specialized for a particular purpose.

In an embodiment, all processes executed in a single service may run within a single service environment, or in multiple service environments. Multiple processes executed in a single service could be provided by different service environments.

The network 430 is a network that exchanges information between the UE 410 and the service environment 420. The network 430 includes one or more wired and/or wireless networks.

For example, the network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 430 can be a part of a network. For example, in a 5G network that includes a RAN, a transport network, and a core network, the network 430 can be at least one of the RAN, the transport network, or the core network. For example, the service environment 420 could be in the core network, in which case the network 430 could correspond to a network that is a combination of a RAN and a transport network and is part of the 5G network.

The number and arrangement of devices and networks shown in FIG. 4 are provided as an example. It should be understood that any changes that may be implemented by those skilled in the art, such as the addition or rearrangement of well-known devices or networks at the time of implementation, are included in this disclosure.

Various further respective aspects and features of embodiments of the present disclosure may be defined by the following items:

Item [1]: An apparatus that may be configured to: communicate with a core network via a first communication unit comprising one of a distributed communication unit and a centralized communication unit; detect a failure at the first communication unit; and switch communication to a second communication unit comprising another of the distributed communication unit and the centralized communication unit; wherein the distributed communication unit may include a radio interface unit of distributed unit (RIU-D) or a next generation distributed unit (NGDU), and wherein the centralized communication unit may include a secure telephone unit (STU).

Item [2]: The apparatus according to item [1], wherein the distributed communication unit and the centralized communication unit may both be installed at a cell site.

Item [3]: The apparatus according to one of items [1]-[2], wherein the apparatus may include a remote radio head (RRH) communicatively coupled to both the distributed communication unit and the centralized communication unit.

Item [4]: The apparatus according to one of items [1]-[3], wherein the RIU-D and the NGDU may be part of a distributed radio access network (DRAN) architecture.

Item [5]: The apparatus according to one of items [1]-[4], wherein the STU may be part of a centralized radio access network (CRAN) architecture.

Item [6]: The apparatus according to one of items [1]-[5], wherein the apparatus may be configured to switch communication to the second communication unit automatically after detecting the failure.

Item [7]: The apparatus according to one of items [1]-[6], wherein the apparatus may be configured to switch communication to the second communication unit in response to receiving a request to switch communication unit.

Item [8]: The apparatus according to one of items [1]-[7], wherein the failure may include a failure associated with hardware of the first communication unit.

Item [9]: The apparatus according to one of items [1]-[8], wherein the apparatus may be further configured to transmit a failure notification including information related to the detected failure.

Item [10]: A method that may include: communicating with a core network via a first communication unit comprising one of a distributed communication unit and a centralized communication unit; detecting a failure at the first communication unit; and switching communication to a second communication unit comprising another of the distributed communication unit and the centralized communication unit; wherein the distributed communication unit may include a radio interface unit of distributed unit (RIU-D) or a next generation distributed unit (NGDU), and wherein the centralized communication unit may include a secure telephone unit (STU).

Item [11]: The method according to item [10], wherein the distributed communication unit and the centralized communication unit may both be installed at a cell site.

Item [12]: The method according to one of items [10]-[11], wherein the method may be performed by a remote radio head (RRH) communicatively coupled to both the distributed communication unit and the centralized communication unit.

Item [13]: The method according to one of items [10]-[12], wherein the RIU-D and the NGDU may be part of a distributed radio access network (DRAN) architecture.

Item [14]: The method according to one of items [10]-[13], wherein the STU may be part of a centralized radio access network (CRAN) architecture.

Item [15]: The method according to one of items [10]-[14], wherein the communication may be switched to the second communication unit automatically after detecting the failure.

Item [16]: The method according to one of items [10]-[15], wherein the communication may be switched to the second communication unit in response to receiving a request to switch communication unit.

Item [17]: The method according to one of items [10]-[16], wherein the failure may include a failure associated with hardware of the first communication unit.

Item [18]: The method according to one of items [10]-[17], wherein the method may further include transmitting a failure notification including information related to the detected failure.

Item [19]: A non-transitory computer-readable recording medium that may have recorded thereon instructions executable by an apparatus to cause the apparatus to perform a method including: communicating with a core network via a first communication unit comprising one of a distributed communication unit and a centralized communication unit; detecting a failure at the first communication unit; and switching communication to a second communication unit comprising another of the distributed communication unit and the centralized communication unit; wherein the distributed communication unit may include a radio interface unit of distributed unit (RIU-D) or a next generation distributed unit (NGDU), and wherein the centralized communication unit may include a secure telephone unit (STU).

Item [20]: The non-transitory computer-readable recording medium according to item [19], wherein the distributed communication unit and the centralized communication unit may both be installed at a cell site.

It is understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus configured to:
communicate with a core network via a first communication unit comprising one of a distributed communication unit and a centralized communication unit;
detect a failure at the first communication unit; and
switch communication to a second communication unit comprising another of the distributed communication unit and the centralized communication unit;
wherein the distributed communication unit comprises a radio interface unit of distributed unit (RIU-D) or a next generation distributed unit (NGDU), and wherein the centralized communication unit comprises a secure telephone unit (STU).

2. The apparatus according to claim 1, wherein the distributed communication unit and the centralized communication unit are both installed at a cell site.

3. The apparatus according to claim 1, wherein the apparatus comprises a remote radio head (RRH) communicatively coupled to both the distributed communication unit and the centralized communication unit.

4. The apparatus according to claim 1, wherein the RIU-D and the NGDU are part of a distributed radio access network (DRAN) architecture.

5. The apparatus according to claim 1, wherein the STU is part of a centralized radio access network (CRAN) architecture.

6. The apparatus according to claim 1, wherein the apparatus is configured to switch communication to the second communication unit automatically after detecting the failure.

7. The apparatus according to claim 1, wherein the apparatus is configured to switch communication to the second communication unit in response to receiving a request to switch communication unit.

8. The apparatus according to claim 1, wherein the failure comprises a failure associated with hardware of the first communication unit.

9. The apparatus according to claim 1, wherein the apparatus is further configured to transmit a failure notification including information related to the detected failure.

10. A method comprising:
communicating with a core network via a first communication unit comprising one of a distributed communication unit and a centralized communication unit;
detecting a failure at the first communication unit; and
switching communication to a second communication unit comprising another of the distributed communication unit and the centralized communication unit;
wherein the distributed communication unit comprises a radio interface unit of distributed unit (RIU-D) or a next generation distributed unit (NGDU), and wherein the centralized communication unit comprises a secure telephone unit (STU).

11. The method according to claim 10, wherein the distributed communication unit and the centralized communication unit are both installed at a cell site.

12. The method according to claim 10, wherein the method is performed by a remote radio head (RRH) communicatively coupled to both the distributed communication unit and the centralized communication unit.

13. The method according to claim 10, wherein the RIU-D and the NGDU are part of a distributed radio access network (DRAN) architecture.

14. The method according to claim 10, wherein the STU is part of a centralized radio access network (CRAN) architecture.

15. The method according to claim 10, wherein the communication is switched to the second communication unit automatically after detecting the failure.

16. The method according to claim 10, wherein the communication is switched to the second communication unit in response to receiving a request to switch communication unit.

17. The method according to claim 10, wherein the failure comprises a failure associated with hardware of the first communication unit.

18. The method according to claim 10, wherein the method further comprises transmitting a failure notification including information related to the detected failure.

19. A non-transitory computer-readable recording medium having recorded thereon instructions executable by an apparatus to cause the apparatus to perform a method comprising:
communicating with a core network via a first communication unit comprising one of a distributed communication unit and a centralized communication unit;
detecting a failure at the first communication unit; and
switching communication to a second communication unit comprising another of the distributed communication unit and the centralized communication unit;
wherein the distributed communication unit comprises a radio interface unit of distributed unit (RIU-D) or a next generation distributed unit (NGDU), and wherein the centralized communication unit comprises a secure telephone unit (STU).

20. The non-transitory computer-readable recording medium according to claim 19, wherein the distributed communication unit and the centralized communication unit are both installed at a cell site.
